(19) United States
(12) Patent Application Publication
(10) Pub. No.: US 2026/0172287 A1
(43) Pub. Date: Jun. 18, 2026

(54) USER EQUIPMENT FOR CHANNEL ESTIMATION AND OPERATION METHOD THEREOF

(71) Applicant: SAMSUNG ELECTRONICS CO. LTD., Suwon-si (KR)

(72) Inventors: Jeongsoon Park, Suwon-si (KR); Hoil Kim, Suwon-si (KR); Youngwoo Ko, Suwon-si (KR); Jinho Kim, Suwon-si (KR)

(73) Assignee: SAMSUNG ELECTRONICS CO. LTD., Suwon-si (KR)

(21) Appl. No.: 19/422,660

(22) Filed: Dec. 17, 2025

(30) Foreign Application Priority Data
Dec. 18, 2024 (KR) 10-2024-0190459

(51) Int. Cl. H04L 25/02; H04B 7/06; H04L 5/00

(52) U.S. Cl. CPC H04L 25/0202; H04B 7/0626; H04L 5/0044

(57) ABSTRACT

A user equipment configured to communicate with a base station, may include a plurality of antennas configured to receive reference signals from the base station, at least one buffer memory configured to store the reference signals sequentially, processing circuitry configured to receive the reference signals from the at least one buffer memory and estimate a channel for a transmission symbol using a channel estimation model, based on the received reference signals. The number of the at least one buffer memory may be less than the number of the reference signals.

### CROSS-REFERENCE TO RELATED APPLICATION

This application is based on and claims priority under 35 U.S.C. § 119 to Korean Patent Application No. 10-2024-0190459, filed on Dec. 18, 2024, in the Korean Intellectual Property Office, the disclosure of which is incorporated by reference herein in its entirety.

### BACKGROUND

Apparatus and methods consistent with embodiments of the present disclosure relate to wireless communication, and more particularly, to a user equipment for channel estimation and an operation method of the user equipment.

Base stations (BSs) may transmit reference signals to user equipments (UEs) to identify channel conditions between BSs and UEs. For example, BSs may transmit channel state information-reference signals (CSI-RSs) to allow the UEs to estimate the channels between the BSs and the UEs. The UEs may estimate channels between the BSs and the UEs based on the CSI-RSs received from the BSs. That is, the UEs may estimate channels between the BSs and the UEs based on CSI-RSs. The UEs may report, to the BSs, feedback information regarding estimated channels. Feedback information may include precoding matrix indicators (PMIs), rank indicators (RIs), and channel quality indicators (CQIs). The BSs may design precoders for downlink channels by using feedback information.

When the UEs estimate channels between the BSs and the UEs based on CSI-RSs, channel estimation values may vary over time due to particular environmental changes, such as the movement of the UEs or BSs. Therefore, there is a demand for an efficient method of channel estimation at a particular time point in the future.

### SUMMARY

One or more embodiments provide a user equipment for storing reference signals individually and/or sequentially and estimating a channel for a particular symbol by using a channel estimation model, based on the stored reference signals, and also provide an operation method of the user equipment.

According to an aspect of the present disclosure, there is provided a user equipment configured to communicate with a base station, the user equipment including a plurality of antennas configured to receive reference signals from the base station, at least one buffer memory configured to store the reference signals sequentially, processing circuitry configured to receive the reference signals from the at least one buffer memory and estimate a channel for a transmission symbol using a channel estimation model, based on the received reference signals. The number of the at least one buffer memory may be less than the number of the reference signals.

According to another aspect of the present disclosure, there is provided an operation method of a user equipment that is configured to receive reference signals and includes at least one buffer memory, the operation method including receiving a first reference signal from among the reference signals, storing the first reference signal in the at least one buffer memory, generating a first estimated value by using a channel estimation model, based on the stored first reference signal, receiving a second reference signal from among the reference signals, the second reference signal being received after the first reference signal, storing the second reference signal instead of the first reference signal, in the at least one buffer memory, while the first estimated value is being generated, generating a second estimated value by using the channel estimation model, based on the first estimated value and the stored second reference signal, and generating the second estimated value as a channel estimation value for a transmission symbol, based on the second reference signal being a last reference signal from among the reference signals, wherein the number of the at least one buffer memory is less than the number of the reference signals.

According to another aspect of the present disclosure, there is provided a user equipment configured to communicate with a base station, the user equipment including a plurality of antennas configured to sequentially receive reference signals from the base station, a single buffer memory configured to sequentially store the reference signals, and processing circuitry configured to sequentially receive the reference signals from the single buffer memory and estimate a channel for a transmission symbol by using a channel estimation model, based on the reference signals.

### BRIEF DESCRIPTION OF THE DRAWINGS

Embodiments will be more clearly understood from the following detailed description taken in conjunction with the accompanying drawings in which:

FIG. 1 is a block diagram illustrating a wireless communication system according to some embodiments;

FIG. 2 is a diagram illustrating a basic structure of a time-frequency domain, which is a radio resource region in a wireless communication system, according to one or more embodiments;

FIG. 3 is a block diagram illustrating a user equipment according to one or more embodiments;

FIG. 4 is a flowchart illustrating an operation method of a user equipment, according to one or more embodiments;

FIG. 5 is a diagram illustrating an operation method of a user equipment, according to one or more embodiments;

FIG. 6 is a block diagram illustrating a user equipment according to a comparative example;

FIG. 7 is a block diagram illustrating a user equipment according to one or more embodiments;

FIG. 8 is a block diagram illustrating a user equipment according to one or more embodiments;

FIG. 9 is a graph illustrating a comparison between a user equipment according to one or more embodiments and a user equipment according to a comparative example;

FIG. 10 is a block diagram illustrating an electronic device according to one or more embodiments; and

FIG. 11 is a conceptual diagram illustrating an Internet-of-Things (IoT) network system to which one or more embodiments is applied.

### DETAILED DESCRIPTION

Hereinafter, embodiments of the inventive concept will be described in detail with reference to the accompanying drawings.

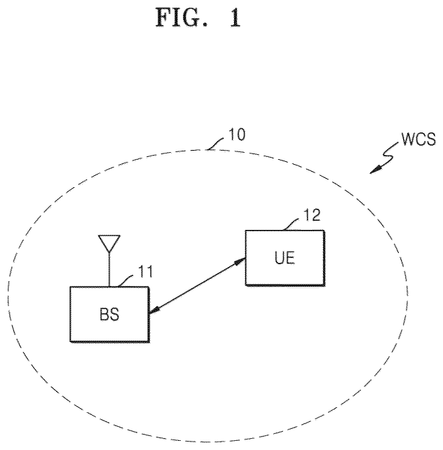

FIG. 1 is a block diagram illustrating a wireless communication system WCS according to some embodiments.

Although embodiments of the present disclosure are described hereinafter in accordance with new radio (NR) network-based wireless communication systems, in particular, the 3^{rd} Generation Partnership Project (3GPP) releases, the embodiments are not limited to the NR networks and may also be applied to other wireless communication systems (for example, cellular communication systems, such as long-term evolution (LTE) systems, LTE-advanced (LTE-A) systems, wireless broadband (WiBro) systems, global system for mobile communication (GSM) systems, or next-generation (for example, 6G) communication systems, or short-range communication systems, such as Bluetooth systems or near-field communication (NFC) systems) having similar technical backgrounds or channel settings).

In embodiments described below, a hardware approach is described as an example. However, because embodiments of the present disclosure include a technique using both hardware and software, the embodiments do not exclude software-based approaches.

Various functions described below may be implemented or supported by artificial intelligence technology or by one or more computer programs, and each of the programs includes computer-readable program code and is implemented on a computer-readable medium. The terms “application” and “program” refer to one or more computer programs, software components, instruction sets, procedures, functions, objects, classes, instances, related data, or portions thereof suitable for the implementation of suitable computer-readable program code. The term “computer-readable program code” includes any types of computer code including source code, object code, and execution code. The term “computer-readable medium” includes any types of media, such as read-only memory (ROM), random access memory (RAM), hard disk drives, compact discs (CDs), digital video disks (DVDs), or any other types of memory, which may be accessed by computers. A “non-transitory” computer-readable medium does not include wired, wireless, optical, or other communication links for transmitting temporary electrical or other signals. Non-transitory computer-readable media include media in which data may be permanently stored, and media in which data may be stored and overwritten afterward, such as rewritable optical disks or erasable memory devices.

Referring to FIG. 1, a wireless communication system WCS may include a base station 11 and a user equipment 12. The base station 11 may refer to a fixed station or a network endpoint (including a mobile hot spot) that communicates with the user equipment 12 and/or other base stations to exchange data and control information with the user equipment 12 and/or the other base stations. For example, the base station 11 may be referred to as a Node B, an evolved-Node B (eNB), a next-generation Node B (gNB), a sector, a site, a base transceiver system (BTS), an access point (AP), a relay node, a remote radio head (RRH), a radio unit (RU), a small cell, a wireless device, or the like. The base station 11 may provide wireless broadband access to the user equipment 12 within a coverage 10 of the base station 11.

The user equipment 12 may refer to any equipment that is stationary or mobile and may transmit data and/or control information to and receive data and/or control information from the base station 11 by communicating with the base station 11. For example, the user equipment 12 may be referred to as a terminal, a terminal equipment, a mobile station (MS), a mobile terminal (MT), a user terminal (UT), a subscribe station (SS), a wireless device, a handheld device, or the like. Although only one user equipment 12 is illustrated herein, the embodiments not limited thereto. For example, the wireless communication system WCS may further include other user equipments in addition to the user equipment 12.

The base station 11 may transmit at least one reference signal to the user equipment 12 to identify channel conditions between the base station 11 and the user equipment 12 and to obtain channel information that reflects the channel conditions. For example, the reference signal may include one of a channel state information-reference signal (CSI-RS) and a demodulation-reference signal (DM-RS).

In some embodiments, the base station 11 may transmit a CSI-RS to identify the channel information between the base station 11 and the user equipment 12. The user equipment 12 may estimate a channel between the base station 11 and the user equipment 12 through the CSI-RS received from the base station 11. The user equipment 12 may report, to the base station 11, feedback information regarding the estimated channel. The feedback information may include a precoding matrix indicator (PMI), a rank indicator (RI), and a channel quality indicator (CQI). The base station 11 may design a precoder for a downlink channel by using the feedback information.

A time point at which the user equipment 12 receives the CSI-RS may be different from a time point at which the user equipment 12 reports the feedback information to the base station 11. During this time interval, variations in the wireless channel may arise due to environmental dynamics, such as movement of the UE 12 or the base station 11, leading to the Doppler effect. The Doppler effect may refer to the change in the frequency and wavelength of a certain wave depending on the relative velocity between an observer and a source of the wave. Due to the Doppler effect, the channel conditions estimated at the time of CSI-RS reception may not accurately reflect the actual channel state at the time feedback is reported to the base station 11. This time offset may cause feedback information reported by the UE 12 to diverge from the instantaneous channel conditions at the base station 11, thus degrading downlink precoding or scheduling decisions.

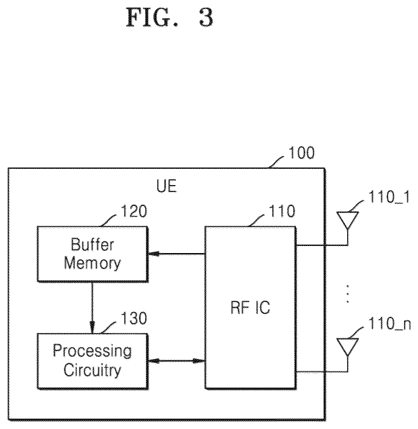

To solve this issue, the user equipment 12 may receive a sequence of CSI-RSs over time and, based on the CSI-RSs, may apply a channel estimation model to estimate the CIS for a future time instance, specifically for a symbol that occurs after the last received CSI-RS. The predicted CSI may represent feedback information generated by taking into account the particular environmental change (for example, the movement of the user equipment 12 or the base station 11). Therefore, the user equipment 12 may solve the issue due to the Doppler effect, thereby improving channel estimation performance. Specific embodiments of the channel estimation model are described below with reference to FIGS. 3 to 9.

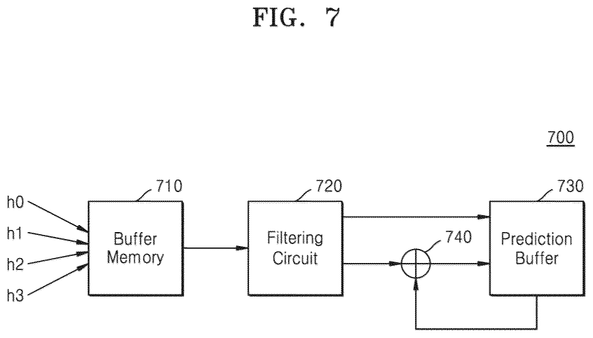

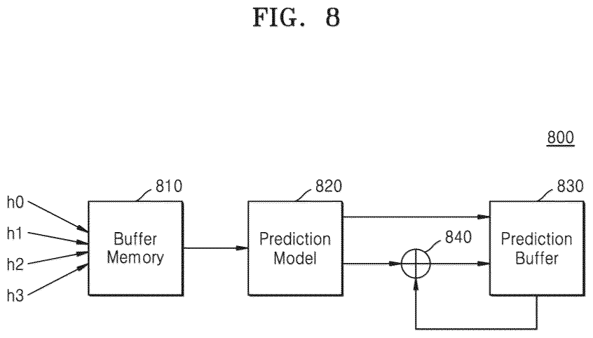

In addition, the user equipment 12 may have further improved channel estimation performance as the number of received CSI-RSs increases. For example, the predicted CSI generated based on a relatively large number of CSI-RSs may be more accurate than the predicted CSI generated based on a relatively small number of CSI-RSs. Although the user equipment 12 may need to include a relatively larger number of buffer memories to store the received CSI-RSs as the number of received CSI-RSs increases, because the user equipment 12 according to the embodiments performs channel estimation by sequentially using the received CSI-RSs without retaining all previously received CSI-RSs, the user equipment 12 may include a smaller number of buffer memories than the number of received CSI-RSs. Therefore, the user equipment 12 may reduce the size of the buffer memory for storing the reference signal. Specific embodiments of the buffer memory are described below with reference to FIGS. 7 and 8.

In some embodiments, the base station 11 may transmit at least one DM-RS to identify the channel information between the base station 11 and the user equipment 12. The user equipment 12 may estimate the channel between the base station 11 and the user equipment 12 through the DM-RS received from the base station 11. For example, the channel may include one of a physical data shared channel (PDSCH) and a physical downlink control channel (PDCCH). For example, the channel may include a channel for a particular symbol that is different from a symbol corresponding to the at least one DM-RS. The user equipment 12 may report feedback information regarding the estimated channel to the base station 11. The feedback information may include a modulation and coding scheme (MCS), channel quality indicator (CQI), precoding matrix indicator (PMI), rank indicator (RI), and transmission scheduling accuracy, and the like. The base station 11 may using the feedback information to correct or mitigate channel distortion.

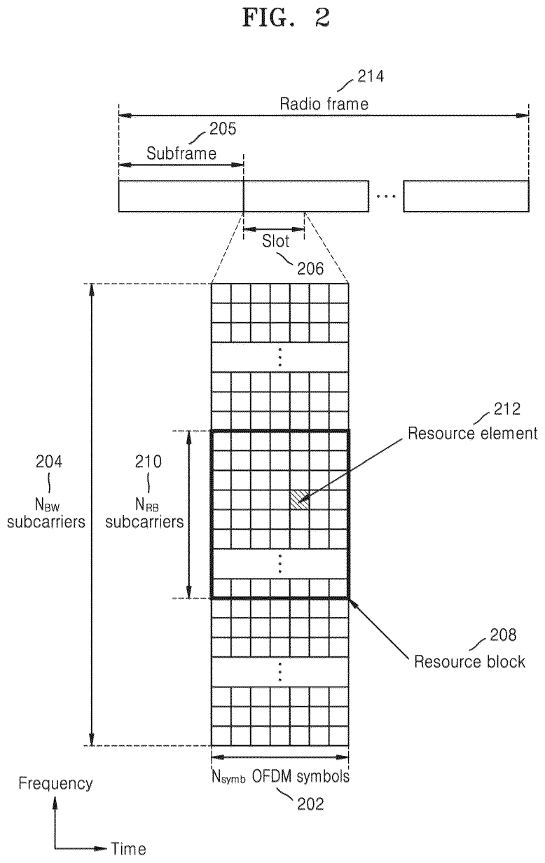

FIG. 2 is a diagram illustrating a basic structure of a time-frequency domain, which is a radio resource region in a wireless communication system, according to one or more embodiments.

Referring to FIG. 2, the horizontal axis represents a time domain, and the vertical axis represents a frequency domain. A minimum transmission unit in the time domain is an Orthogonal Frequency Division Multiplexing (OFDM) symbol, and N_{symb} OFDM symbols 202 may be combined to constitute one slot 206. The OFDM symbol is an example of a transmission symbol or modulation symbol, and in the present disclosure, it may be also referred to as a transmission symbol or modulation symbol. Two slots may constitute one subframe 205. For example, the length of the slot 206 may be 0.5 ms, and the length of the subframe 205 may be 1.0 ms. However, this is only an example. The length of the slot 206 may vary with the configuration of the slot 206, and the number of slots 206, which are included in the subframe 205, may vary with the length of the slot 206. In an NR network, the time-frequency domain may be defined with a focus on the slot 206. In addition, a radio frame 214 may be a unit of the time domain, which includes 10 subframes 205.

A minimum transmission unit in the frequency domain is a subcarrier, and the bandwidth of the whole system transmission band may include N_{BW} subcarriers 204. In the time-frequency domain, a basic unit of a resource is a resource element (RE) 212 and may be represented by an OFDM symbol index and a subcarrier index. A resource block (RB) 208 may be defined by N_{symb} consecutive OFDM symbols 202 in the time domain and N_{RB} consecutive subcarriers 210 in the frequency domain. Therefore, one RB 208 may include (N_{symb}*N_{RB}) REs 212. An RB pair refers to a unit where two RBs are contiguous along the time axis and may include of (N_{symb}*2NRB) REs 212.

At least one reference signal may be transmitted from a base station (for example, the base station 11 of FIG. 1) to a user equipment (for example, the user equipment 12 of FIG. 1) in a wireless communication system through the resource in the time-frequency domain as shown in FIG. 2. For example, the at least one reference signal may be transmitted from the base station (for example, the base station 11 of FIG. 1) to the user equipment (for example, the user equipment 12 of FIG. 1) every two slots 206.

FIG. 3 is a block diagram illustrating a user equipment 100 according to one or more embodiments. In some embodiments, the user equipment 100 of FIG. 3 may be an example of the user equipment 12 of FIG. 1, and repeated descriptions given with reference to FIG. 1 are omitted.

Referring to FIG. 3, the user equipment 100 may include a radio-frequency (RF) integrated circuit 110, a plurality of antennas 110_1 to 110_n, at least one buffer memory 120, and processing circuitry 130.

The RF integrated circuit 110 may receive RF signals, which are transmitted by the base station 11 of FIG. 1, through the antennas 110_1 to 110_n. The RF integrated circuit 110 may generate intermediate-frequency or baseband signals by down-converting the received RF signals. The processing circuitry 130 may generate data signals by filtering, decoding, and/or digitalizing the intermediate-frequency or baseband signals. In addition, the data signals may be encoded, multiplexed, and/or analogized. The RF integrated circuit 110 may frequency-upconvert the intermediate-frequency or baseband signals, which are output from the processing circuitry 130, and may transmit the frequency-upconverted intermediate-frequency or baseband signals as RF signals through the antennas 110_1 to 110_n.

In some embodiments, the RF integrated circuit 110 may receive at least one reference signal from the base station 11 through the antennas 110_1 to 110_n and may transmit the at least one reference signal to the at least one buffer memory 120.

The at least one buffer memory 120 may be configured to store the received at least one reference signal one-by-one (i.e., individually and/or sequentially). For example, the at least one buffer memory 120 may store reference signals, replacing a previously stored reference signal with a newly received reference signal in a continuous update. In some embodiments, the number of the at least one buffer memory 120 may be less than the number of the received at least one reference signal. For example, when the number of the received at least one reference signal is N (where N is an integer of 2 or more), the number of the at least one buffer memory 120 may be M (where M is an integer of at least 1 but not more than N). For example, the number of the at least one buffer memory 120 may be 1.

The processing circuitry 130 may sequentially receive the stored at least one reference signal from the at least one buffer memory 120 and may estimate a channel for a particular symbol by using a channel estimation model, based on the received at least one reference signal.

In some embodiments, the reference signal may include a CSI-RS, the channel for the particular symbol may include a channel corresponding to a particular slot after a slot corresponding to the reference signal, and the processing circuitry 130 may generate predicted CSI corresponding to the particular slot. The predicted CSI may include a PMI, an RI, and a CQI, which correspond to the particular slot.

For example, the number of the at least one buffer memory 120 may be one (1), and the CSI-RS may be transmitted from a base station (for example, the base station 11 of FIG. 1) to the user equipment 100 every two slots. The at least one buffer memory 120 may store one CSI-RS every two slots. In other words, the at least one buffer memory 120 may forward the CSI-RS stored every two slots to the processing circuitry 130 and may sequentially store the next received CSI-RS in place of the previously stored CSI-RS. The processing circuitry 130 may sequentially receive the CSI-RS one-by-one from the at least one buffer memory 120 and may generate the predicted CSI corresponding to the particular slot by using the channel estimation model.

In some embodiments, the channel estimation model may include a filtering model. The filtering model may refer to a model for correcting a channel state function by using a past channel sample in order to estimate the channel state function.

For example, the filtering model may include a Time-Domain Minimum Mean Squared Error (TD MMSE) filtering model that is based on Jakes model time correlation.

For example, the processing circuitry 130 may sequentially receive the CSI-RS one-by-one from the at least one buffer memory 120 and may perform a filtering operation to generate a filtering value by applying a weight vector to each CSI-RS. The weight vector may be predetermined based on parameters such as the velocity of the user equipment 100 and a carrier frequency of the CSI-RS. The processing circuitry 130 may perform an addition operation to generate a summed value by adding the filtering value generated based on the currently received CSI-RS to a filtering value generated based on a previously received CSI-RS (for example, a filtering value generated based on a CSI-RS received directly before the received CSI-RS). When the currently received CSI-RS is the last CSI-RS received in a sequence, the processing circuitry 130 may use the most recently generated summed value as the predicted CSI.

In some embodiments, the channel estimation model may include a machine learning model. For example, the machine learning model may use CSI-RSs as input data and may be configured to output feedback information (for example, the predicted CSI), which corresponds to a future time point relative to the time points which a plurality of CSI-RSs were received. The machine learning model may use a sequence of received CSI-RSs as input to generate the predicted CSI. The machine learning model may be based on supervised learning that is trained with labeled data (i.e., known channel conditions) or unsupervised learning for real-time estimation without prior knowledge of the channel. Neural networks (e.g., convolutional neural networks (CNN) or recurrent neural networks (RNN) may be used to constitute the machine learning model.

In some embodiments, the reference signal may include a DM-RS, and here, the channel for the particular symbol may include a channel (for example, the channel includes one of a PDCCH and a PDSCH) corresponding to a particular slot that is different from a slot in which the reference signal is transmitted. The processing circuitry 130 may generate feedback information corresponding to the particular slot. The feedback information may include a modulation method, channel quality, the accuracy of transmission scheduling information, and the like.

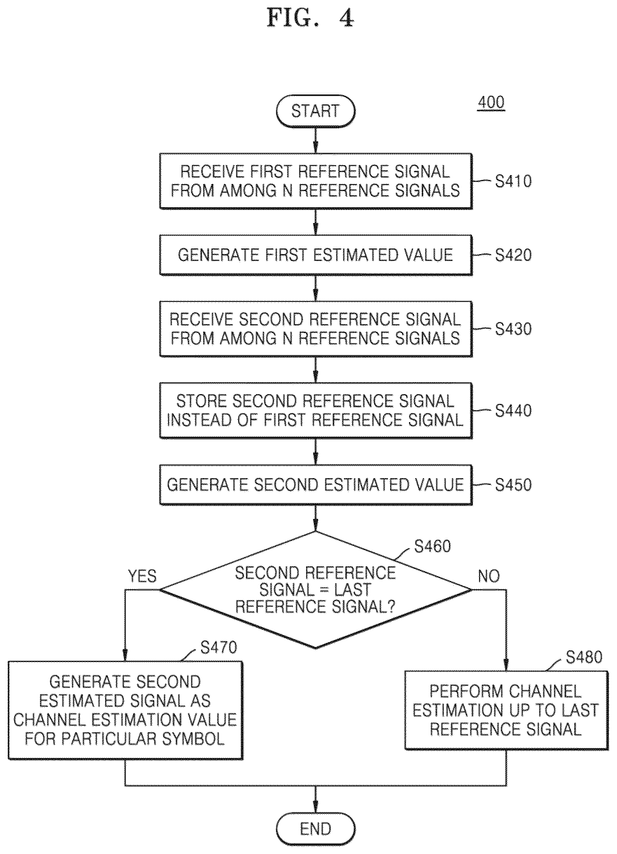

FIG. 4 is a flowchart illustrating an operation method 400 of a user equipment, according to one or more embodiments. Referring to FIG. 4, the operation method 400 of the user equipment may include operations S410 to S480. The user equipment may be an example of one of the user equipment 12 of FIG. 1 and the user equipment 100 of FIG. 3, and repeated descriptions given with reference to FIGS. 1 and 3 are omitted.

Referring further to FIG. 1, in operation S410, the user equipment 12 may receive, from the base station 11, a first reference signal from among N reference signals (where N is an integer of 2 or more). In some embodiments, the user equipment 12 may cyclically receive N reference signals from the base station 11 and may receive a first reference signal that is a reference signal received first from among the N reference signals. For example, the user equipment 12 may sequentially receive N reference signals every n slots (where n is an integer of 1 or more) and may receive a first reference signal that is a reference signal received first from among the N reference signals.

In operation S420, the user equipment 12 may generate a first estimated value. In some embodiments, the user equipment 12 may store the first reference signal in at least one buffer (for example, the buffer memory 120 of FIG. 3) and may generate the first estimated value by using a channel estimation model, based on the stored first reference signal. For example, the channel estimation model may include one of the filtering model and the machine learning model, which are described with reference to FIG. 3. For example, the user equipment 12 may generate a first filtering value as the first estimated value by applying a first weight vector to the first reference signal.

In operation S430, the user equipment 12 may receive a second reference signal from among the N reference signals. In some embodiments, the user equipment 12 may receive, from the base station 11, the second reference signal that is a next reference signal after the first reference signal. For example, the second reference signal may be a reference signal that is received after n slots following the reception of the first reference signal.

In operation S440, the user equipment 12 may store the second reference signal instead of the first reference signal. In some embodiments, the at least one buffer (for example, the buffer memory 120 of FIG. 3) may transmit a reference signal, which is stored every n slots, to processing circuitry (for example, the processing circuitry 130 of FIG. 3) and may store a newly received reference signal instead of the existing stored reference signal. For example, the user equipment 12 may store the first reference signal, may receive the second reference signal after two slots, and may store the newly received second reference signal instead of the stored first reference signal.

In operation S450, the user equipment 12 may generate a second estimated value. In some embodiments, the user equipment 12 may generate the second estimated value by using the channel estimation model, based on the first estimated value and the stored second reference signal. For example, the user equipment 12 may generate an output value by applying a weight vector to the stored second reference signal and may generate the second estimated value by adding the first estimated value to the output value. For example, the user equipment 12 may generate a second filtering value by applying a second weight vector to the stored second reference signal and may generate the second estimated value by adding the first estimated value to the second filtering value.

In operation S460, the user equipment 12 may determine whether the second reference signal is the last reference signal from among the N reference signals. For example, when N is 2, the user equipment 12 may determine that the second reference signal is the last reference signal. When N is 3 or more, the user equipment 12 may determine that the second reference signal is not the last reference signal.

When it is determined that the second reference signal is the last reference signal from among the N reference signals, the user equipment 12 may generate the second estimated value as a channel estimation value for a particular symbol in operation S470. For example, the user equipment 12 may generate the second estimated value as feedback information.

When it is not determined that the second reference signal is the last reference signal from among the N reference signals, the user equipment 12 may perform channel estimation up to the last reference signal in operation S480. The channel estimation may refer to an operation, performed by the user equipment 12, of generating the channel estimation value for the particular symbol by using the channel estimation model. For example, the user equipment 12 may perform operations S430 to S460 on a third reference signal that is a next reference signal after the second reference signal.

While operations S410 to S460 and S480 are performed, the machine learning model may iteratively update its model parameters (e.g., weights and biases) as new input data, such as a time-ordered sequence of reference signals (e.g., the first, second, through n-th reference signals), is provided. Upon receiving a reference signal at time T₁₋₁, the machine learning model may process this input to generate a predicted channel estimate for a future time point T₂₋₁, where T₂₋₁ is a time after T₁₋₁. Subsequently, when the next reference signal is received at time T₁₋₂, the previously stored reference signal (received at T₁₋₁) may be removed from the buffer memory. The new reference signal is then fed into the machine learning model to generate a channel estimate for another future time point, T₂₋₂, where T₂₋₂ is a time after T₁₋₂. This process continues iteratively, where each newly received reference signal replaces the oldest one in the buffer, and the machine learning model continuously outputs updated channel estimates for respective future time points. The iteration may be repeated until channel estimation has been performed for the entire sequence, up to and including the last reference signal. The approach allows the machine learning model to adapt to temporal channel variations and supports real-time or near-real-time predictive channel estimation based on sequentially streaming input.

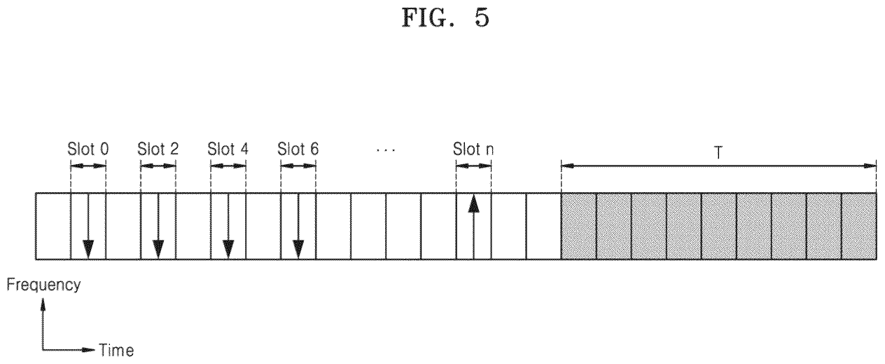

FIG. 5 is a diagram illustrating an operation method of a user equipment, according to one or more embodiments.

Referring to FIG. 5, the horizontal axis represents the time domain, and the vertical axis represents the frequency domain. The time domain may be in units of slots. Although FIG. 5 illustrates that four reference signals are located every two slots, the embodiments are not limited thereto.

Referring further to FIG. 1, in some embodiments, the user equipment 12 may cyclically receive N reference signals (where N is an integer of 2 or more) from the base station 11. For example, the user equipment 12 may receive, from the base station 11, four reference signals every two slots. The user equipment 12 may receive a first CSI-RS in a first slot (that is, Slot 0) and may receive a second CSI-RS in a second slot (that is, Slot 2). The user equipment 12 may receive a third CSI-RS in a third slot (that is, Slot 4) and may receive a fourth CSI-RS in a fourth slot (that is, Slot 6). The user equipment 12 may generate feedback information for a particular slot (that is, Slot n) by using a channel estimation model, based on the first to fourth CSI-RSs. The base station 11 may design a precoder or may correct channel distortion, for a downlink channel for a time period T, based on the feedback information received from the user equipment 12.

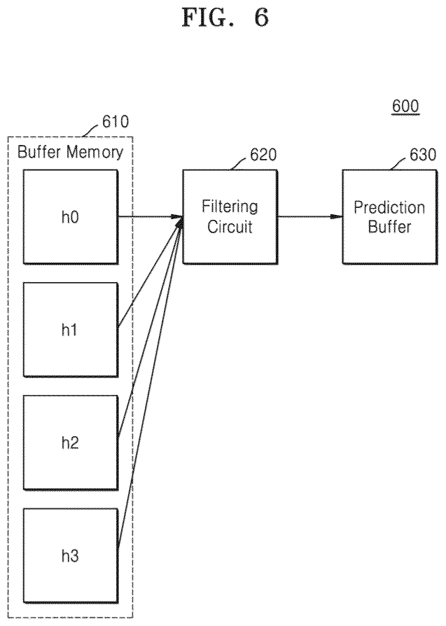

FIG. 6 is a block diagram illustrating a user equipment 600 according to a comparative example. FIG. 7 is a block diagram illustrating a user equipment 700 according to one or more embodiments. Referring to FIGS. 6 and 7, the user equipment 600 according to the comparative example may include a plurality of buffer memories 610, a filtering circuit 620, and a prediction buffer 630, and the user equipment 700 according to one or more embodiments may include a single buffer memory 710, a filtering circuit 720, a prediction buffer 730, and an adder circuit 740. The filtering circuit 620 and the prediction buffer 630 may correspond to the filtering model described above with reference to FIG. 3, and the filtering circuit 720, the prediction buffer 730, and the adder circuit 740 may correspond to the filtering model described above with reference to FIG. 3. The user equipments 600 and 700 may each generate feedback information by using the filtering model, based on a plurality of reference signals.

Referring to FIG. 5, the user equipment 600 may receive first to fourth CSI-RSs, and the plurality of buffer memories 610 including four buffer memories may store each of the first to fourth CSI-RSs as a matrix in each buffer memory. For example, the first CSI-RS may be stored as a first channel matrix h0 in a first buffer memory from among the plurality of buffer memories 610, the second CSI-RS may be stored as a second channel matrix h1 in a second buffer memory from among the plurality of buffer memories 610, the third CSI-RS may be stored as a third channel matrix h2 in a third buffer memory from among the plurality of buffer memories 610, and the fourth CSI-RS may be stored as a fourth channel matrix h3 in a fourth buffer memory from among the plurality of buffer memories 610.

After the first to fourth CSI-RSs are respectively stored in the plurality of buffer memories 610, the filtering circuit 620 may receive the first to fourth CSI-RSs and may generate predicted CSI by applying a weight vector to each of the first to fourth CSI-RSs. For example, the filtering circuit 620 may multiply the first channel matrix h0 by a first weight vector, may multiply the second channel matrix h1 by a second weight vector, may multiply the third channel matrix h2 by a third weight vector, may multiply the fourth channel matrix h3 by a fourth weight vector, and may add up the respective results of the multiplications, thereby generating the predicted CSI. The predicted CSI, which may be feedback information for a particular slot (that is, Slot n), may be stored in the prediction buffer 630 and then reported to a base station (for example, the base station 11 of FIG. 1).

Because the user equipment 600 uses, at once, the plurality of reference signals for generating the feedback information, the user equipment 600 may require a storage space for storing the plurality of reference signals, and thus, the same number of buffer memories 610 as the number of reference signals may be required. For example, the number of buffer memories 610 for storing four CSI-RSs may be 4.

The user equipment 700 according to the embodiments may sequentially receive the first to fourth CSI-RSs, and the single buffer memory 710 may store each of the first to fourth CSI-RSs one-by-one as a matrix.

For example, in the first slot (i.e., Slot 0), the first CSI-RS may be stored as the first channel matrix h0 in the single buffer memory 710, and the single buffer memory 710 may transmit the first channel matrix h0 to the filtering circuit 720 before the second slot (i.e., Slot 2). Between the first slot (i.e., Slot 0) and the second slot (i.e., Slot 2), the filtering circuit 720 may generate a first filtering value by multiplying the first channel matrix h0 by a first weight vector, and the prediction buffer 730 may store the first filtering value.

In the second slot (i.e., Slot 2), the second CSI-RS may be stored as the second channel matrix h1, instead of the first channel matrix h0, in the single buffer memory 710, and the single buffer memory 710 may transmit the second channel matrix h1 to the filtering circuit 720 before the third slot (i.e., Slot 4). Between the second slot (i.e., Slot 2) and the third slot (i.e., Slot 4), the filtering circuit 720 may generate a second filtering value by multiplying the second channel matrix h1 by a second weight vector, the adder circuit 740 may receive the first filtering value from the prediction buffer 730 and may generate a first summed value by adding the first filtering value to the second filtering value, and the prediction buffer 730 may store the first summed value.

In the third slot (i.e., Slot 4), the third CSI-RS may be stored as the third channel matrix h2, instead of the second channel matrix h1, in the single buffer memory 710, and the single buffer memory 710 may transmit the third channel matrix h2 to the filtering circuit 720 before the fourth slot (i.e., Slot 6). Between the third slot (i.e., Slot 4) and the fourth slot (i.e., Slot 6), the filtering circuit 720 may generate a third filtering value by multiplying the third channel matrix h2 by a third weight vector, the adder circuit 740 may receive the first summed value from the prediction buffer 730 and may generate a second summed value by adding the first summed value to the third filtering value, and the prediction buffer 730 may store the second summed value.

In the fourth slot (i.e., Slot 6), the fourth CSI-RS may be stored as the fourth channel matrix h3, instead of the third channel matrix h2, in the single buffer memory 710, and the single buffer memory 710 may transmit the fourth channel matrix h3 to the filtering circuit 720. After the fourth slot (i.e., Slot 6), the filtering circuit 720 may generate a fourth filtering value by multiplying the fourth channel matrix h3 by a fourth weight vector, the adder circuit 740 may receive the second summed value from the prediction buffer 730 and may generate a third summed value by adding the second summed value to the fourth filtering value, and the prediction buffer 730 may store the third summed value.

The prediction buffer 730 may generate the third summed value as the predicted CSI. The predicted CSI, which may be feedback information for a particular slot (i.e., Slot n), may be stored in the prediction buffer 730 and then reported to a base station (for example, the base station 11 of FIG. 1). Although not shown in FIG. 7, the user equipment 700 may further include a controller, and the controller may determine whether a summed value generated by the adder circuit 740 is generated based on the last reference signal and, when the summed value is generated based on the last reference signal, may control the user equipment 700 to report the summed value, which is stored in the prediction buffer 730, as the predicted CSI to the base station (for example, the base station 11 of FIG. 1).

Unlike the user equipment 600, because the user equipment 700 according to the embodiments may generate the predicted CSI by using only the single buffer memory 710, the user equipment 700 may reduce a storage space for storing a plurality of reference signals. For example, when N reference signals are received, the size of the single buffer memory 710 may be 1/N of the total size of the buffer memories 610.

FIG. 8 is a block diagram illustrating a user equipment 800 according to one or more embodiments. Referring to FIG. 8, the user equipment 800 may be an example of the user equipment 100 of FIG. 3 or the user equipment 700 of FIG. 3, and a single buffer memory 810, a prediction buffer 830, and an adder circuit 840 may have the same or substantially the same structure as the single buffer memory 710, the prediction buffer 730, and the adder circuit 740, respectively. Repeated descriptions given with reference to FIGS. 3 and 7 are omitted.

A prediction model 820 may include a model for sequentially receiving N reference signals (where N is an integer of 2 or more) and outputting a channel estimation value for a particular symbol, based on the received N reference signals. In some embodiments, the single buffer memory 810 may sequentially receive four reference signals and may store each of the four reference signals one-by-one as a matrix. For example, first to fourth reference signals may be respectively stored as first to fourth channel matrices h0 to h3.

In some embodiments, the prediction model 820 may include a machine learning model trained based on a plurality of channel matrices and may output feedback information corresponding to a time point that is different from a time point of receiving reference signals respectively corresponding to the plurality of channel matrices, based on the plurality of channel matrices.

For example, the first to fourth reference signals may each include a DM-RS, and the prediction model 820 may include a machine learning model trained based on the first to fourth channel matrices h0 to h3. The prediction model 820 may generate a first output value based on the first channel matrix h0 and may transmit the first output value to the prediction buffer 830.

The prediction model 820 may generate a second output value based on the second channel matrix h1 and may transmit the second output value to the adder circuit 840. The adder circuit 840 may receive the first output value from the prediction buffer 830 and may add the first output value to the second output value, thereby generating a first summed value. The adder circuit 840 may transmit the generated first summed value to the prediction buffer 830.

The prediction model 820 may generate a third output value based on the third channel matrix h2 and may transmit the third output value to the adder circuit 840. The adder circuit 840 may receive the second output value from the prediction buffer 830 and may add the second output value to the third output value, thereby generating a second summed value. The adder circuit 840 may transmit the generated second summed value to the prediction buffer 830.

The prediction model 820 may generate a fourth output value based on the fourth channel matrix h3 and may transmit the fourth output value to the adder circuit 840. The adder circuit 840 may receive the third output value from the prediction buffer 830 and may add the third output value to the fourth output value, thereby generating a third summed value. The adder circuit 840 may transmit the generated third summed value to the prediction buffer 830. The prediction buffer 830 may generate the third summed value as feedback information, and the feedback information may be stored in the prediction buffer 830 and then reported to a base station (for example, the base station 11 of FIG. 1).

The user equipment 800 may further include a processor configured to execute the prediction model 820 and determine whether a summed value generated by the adder circuit 840 is generated based on the last reference signal. When the summed value is generated based on the last reference signal, the processor may control the user equipment 800 to report the summed value, which is stored in the prediction buffer 830, as the feedback information to the base station (for example, the base station 11 of FIG. 1).

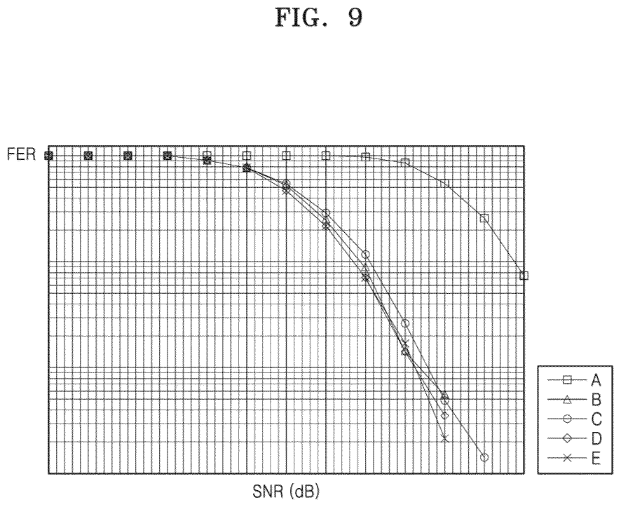

FIG. 9 is a graph illustrating a comparison between a user equipment according to one or more embodiments and a user equipment according to a comparative example.

Referring to FIG. 9, the vertical axis may represent a Frame Error Rate (FER), and the horizontal axis may represent a Signal-to-Noise Ratio (SNR). Example A indicates the performance when a channel estimation model is not used. Examples B and D each indicate the operation performance of the user equipment 600 of FIG. 6. Examples C and E each indicate the operation performance of the user equipment 700 of FIG. 7. Examples B and C correspond to the cases where the number of reference signals is 2. Examples D and E correspond to the cases where the number of reference signals is 4.

In the graph, a curve located further to the lower left side may have relatively higher channel estimation performance, and a curve located further to the upper right side may have relatively lower channel estimation performance. It may be confirmed that Example A exhibits the lowest performance, and it may be confirmed that each of Examples B to E exhibits relatively higher performance. Here, it may be confirmed that, because each of Examples C and E exhibits similar performance to that of each of Examples B and D but includes a relatively smaller-size buffer memory for storing reference signals than that of each of Examples B and D, each of Examples C and E has relatively better space efficiency. In other words, the user equipment 700 according to the embodiments may reduce the size of a memory thereof even while having improved channel estimation performance.

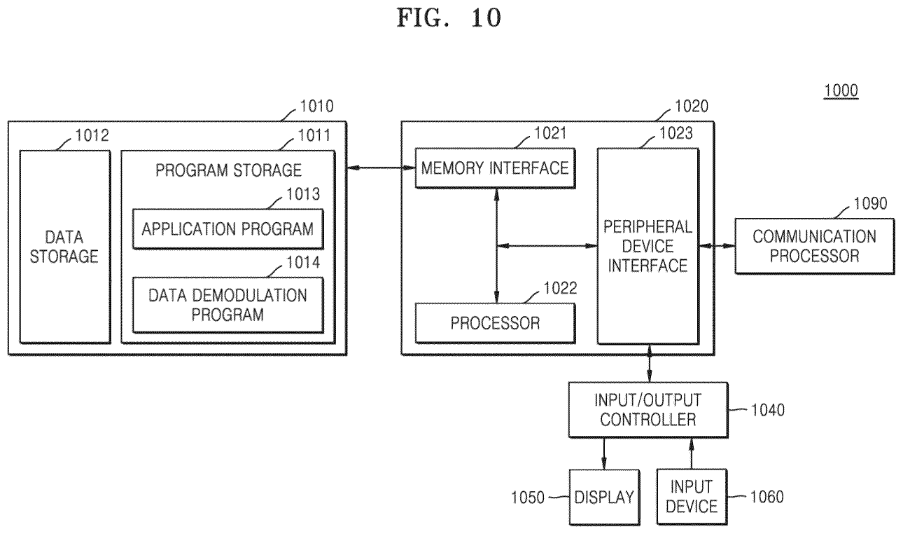

FIG. 10 is a block diagram illustrating an electronic device according to one or more embodiments. An electronic device 1000 may include a user equipment according to one or more embodiments.

Referring to FIG. 10, the electronic device 1000 may include a memory 1010, a processor unit 1020, an input/output controller 1040, a display 1050, an input device 1060, and a communication processor 1090. Here, the memory 1010 may be provided in a plural number. Descriptions of the respective components may be made as follows.

The memory 1010 may include a program storage 1011 storing a program for controlling operations of the electronic device 1000 and a data storage 1012 storing data generated during the execution of the program. The data storage 1012 may store data required for operations of an application program 1013 and a data demodulation program 1014 or may store data generated from the operations of the application program 1013 and the data demodulation program 1014.

The program storage 1011 may include the application program 1013 and the data demodulation program 1014. Here, the program in the program storage 1011 is a set of instructions and may be referred to as an instruction set. The application program 1013 may include pieces of program code for performing various applications that operate on the electronic device 1000. That is, the application program 1013 may include pieces of code (or commands) regarding various applications driven by a processor 1022.

The electronic device 1000 may include the communication processor 1090 configured to perform a communication function for speech communication and data communication. A peripheral device interface 1023 may control connections between the input/output controller 1040, the communication processor 1090, the processor 1022, and a memory interface 1021. By using at least one software program, the processor 1022 controls a plurality of base stations to provide a service corresponding to the software program. Here, by executing at least one program stored in the memory 1010, the processor 1022 may provide a service corresponding to the program.

The processor unit 1020 may include at least one buffer memory and processing circuitry, which are described above with reference to FIGS. 1 to 9, and the number of the at least one buffer memory may be less than the number of received reference signals. The at least one buffer memory may store reference signals one-by-one, and thus, may have a relatively small size. In addition, the processor unit 1020 may perform channel estimation on a particular symbol by using a channel estimation model, and thus, may improve ch63annel estimation performance.

The input/output controller 1040 may provide an interface between input/output devices, such as the display 1050 and the input device 1060, and the peripheral device interface 1023. The display 1050 displays state information, input characters, moving pictures, still pictures, and the like. For example, the display 1050 may display application information regarding applications driven by the processor 1022.

The input device 1060 may provide input data generated through selection by the electronic device 1000 to the processor unit 1020 via the input/output controller 1040. Here, the input device 1060 may include a keypad including at least one hardware button, a touchpad for sensing touch information, and the like. For example, the input device 1060 may provide the touch information, such as a touch, a touch motion, or a touch release, which is sensed by the touchpad, to the processor 1022 via the input/output controller 1040.

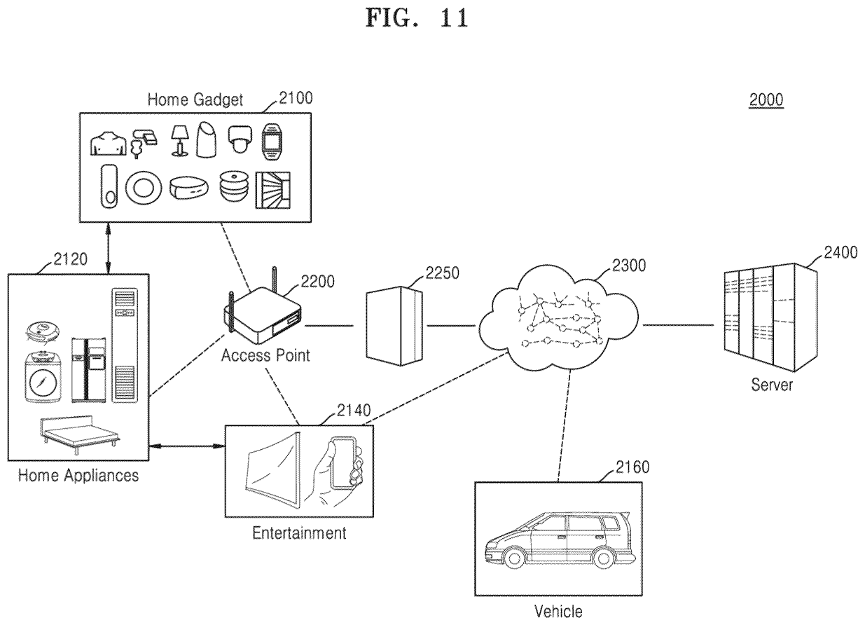

FIG. 11 is a conceptual diagram illustrating an Internet-of-Things (IoT) network system to which one or more embodiments is applied.

Referring to FIG. 11, the IoT network system 2000 may include a plurality of IoT devices (e.g., elements 2100, 2120, 2140, and 2160), an access point 2200, a gateway 2250, a wireless network 2300, and a server 2400. IoT may refer to a network between things using wired/wireless communication.

Each of the IoT devices (e.g., elements 2100, 2120, 2140, and 2160) may form a group, according to characteristics of each IoT device. For example, the IoT devices may be grouped into a home gadget group 2100, a home appliance/furniture group 2120, an entertainment group 2140, a vehicle group 2160, or the like. A plurality of IoT devices (e.g., elements 2100, 2120, and 2140) may be connected to a communication network or another IoT device via the access point 2200. The access point 2200 may be embedded in one IoT device. The gateway 2250 may change a protocol such that the access point 2200 is connected to an external wireless network. The IoT devices (e.g., elements 2100, 2120, and 2140) may be connected to the external communication network via the gateway 2250. The wireless network 2300 may include the Internet and/or a public network. The plurality of IoT devices (e.g., elements 2100, 2120, 2140, and 2160) may be connected, via the wireless network 2300, to the server 2400 providing a certain service, and a user may use the service via at least one of the plurality of IoT devices (e.g., elements 2100, 2120, 2140, and 2160).

The plurality of IoT devices (e.g., elements 2100, 2120, 2140, and 2160) may each include at least one buffer memory and processing circuitry, which are described above with reference to FIGS. 1 to 9, and the number of the at least one buffer memory may be less than the number of received reference signals. The at least one buffer memory may store reference signals one-by-one, and thus, may have a relatively small size. In addition, each of the plurality of IoT devices (e.g., elements 2100, 2120, 2140, and 2160) may perform channel estimation on a particular symbol by using a channel estimation model, and thus, may improve channel estimation performance.

Heretofore, the inventive concept has been particularly shown and described with reference to embodiments thereof and the accompanying drawings. Although the embodiments have been described herein by using particular terms, these terms used herein are only for describing the inventive concept and are not intended to limit the scope of the inventive concept, which is defined by the appended claims. Therefore, it will be understood by those of ordinary skill in the art that there may be various modifications and equivalent embodiments made from the embodiments of the inventive concept. Therefore, the scope of the inventive concept should be defined by the appended claims.

What is claimed is:

1. A user equipment configured to communicate with a base station, the user equipment comprising:
a plurality of antennas configured to receive reference signals from the base station;
at least one buffer memory configured to store the reference signals sequentially; and
processing circuitry configured to receive the reference signals from the at least one buffer memory and estimate a channel for a transmission symbol using a channel estimation model, based on the received reference signals,
wherein a number of the at least one buffer memory is less than a number of the reference signals.

2. The user equipment of claim 1, wherein the processing circuitry is further configured to generate a predicted channel state information-reference Signal (CSI) corresponding to the transmission slot at a future time point, relative to reception times of the reference signals.

3. The user equipment of claim 2, wherein the channel estimation model comprises a machine learning model trained based on the reference signals comprising at least one CSI-RS.

4. The user equipment of claim 3, wherein the channel estimation model is configured to:
perform a first filtering operation to generate a first filtering value by applying a first weight vector to a first CSI-RS, and a second filtering operation to generate a second filtering value by applying a second weight vector to a second CSI-RS received after the first CSI-RS, from among the at least one CSI-RS;
perform an addition operation to generate a summed value by adding the first filtering value to the second filtering value; and
generate the summed value as the predicted CSI, based on the second CSI-RS being a last received CSI-RS from among the at least one CSI-RS.

5. The user equipment of claim 4, wherein the processing circuitry comprises:
a filtering circuit configured to perform the first filtering operation and the second filtering operation;
an adder circuit configured to perform the addition operation; and
a prediction buffer configured to store the first filtering value, the second filtering value, and the summed value.

6. The user equipment of claim 4, wherein the first weight vector and the second weight vector are predetermined based on a velocity of the user equipment and a carrier frequency of the reference signals.

7. The user equipment of claim 1, wherein the number of the at least one buffer memory is 1.

8. The user equipment of claim 7, wherein the reference signals comprise a first reference signal, a second reference signal received after the first reference signal, and a third reference signal received after the second reference signal, and
wherein the at least one buffer memory is further configured to:
store the second reference signal, while the processing circuitry is estimating the channel for the transmission symbol based on the first reference signal; and
store the third reference signal instead of the second reference signal, after transmitting the second reference signal to the processing circuitry.

9. The user equipment of claim 1, wherein
the reference signals comprise at least one Demodulation-Reference Signal (DM-RS), and
the channel comprises one of a Physical Data Shared Channel (PDSCH) and a Physical Downlink Control Channel (PDCCH).

10. An operation method of a user equipment that is configured to receive reference signals and comprises at least one buffer memory, the operation method comprising:
receiving a first reference signal from among the reference signals;
storing the first reference signal in the at least one buffer memory;
generating a first estimated value by using a channel estimation model, based on the stored first reference signal;
receiving a second reference signal from among the reference signals, the second reference signal being received after the first reference signal;
storing the second reference signal instead of the first reference signal, in the at least one buffer memory, while the first estimated value is being generated;
generating a second estimated value by using the channel estimation model, based on the first estimated value and the stored second reference signal; and
generating the second estimated value as a channel estimation value for a transmission symbol, based on the second reference signal being a last reference signal from among the reference signals,
wherein a number of the at least one buffer memory is less than a number of the reference signals.

11. The operation method of claim 10, wherein reference signals respectively comprise Channel State Information-Reference Signals (CSI-RSs), and
the channel estimation value comprises a predicted CSI of a channel corresponding to the transmission slot at a future time point, relative to reception times of the reference signals.

12. The operation method of claim 11, wherein the channel estimation model comprises a machine learning model trained based on the CSI-RSs.

13. The operation method of claim 11, wherein the generating of the first estimated value comprises
generating a first filtering value as the first estimated value by applying a first weight vector to the first reference signal, and
wherein the generating of the second estimated value comprises:
generating a second filtering value by applying a second weight vector to the second reference signal; and
generating the second estimated value by adding the first estimated value to the second filtering value.

14. The operation method of claim 10, wherein the number of the at least one buffer memory is 1.

15. The operation method of claim 10, wherein the reference signals respectively comprise Demodulation-Reference Signals (DM-RSs), and
wherein the channel estimation value comprises one of a Physical Data Shared Channel (PDSCH) and a Physical Downlink Control Channel (PDCCH).

16. A user equipment configured to communicate with a base station, the user equipment comprising:
a plurality of antennas configured to sequentially receive reference signals from the base station;
a single buffer memory configured to sequentially store the reference signals; and
processing circuitry configured to sequentially receive the reference signals from the single buffer memory and estimate a channel for a transmission symbol by using a channel estimation model, based on the reference signals.

17. The user equipment of claim 16, wherein the processing circuitry is further configured to generate a predicted channel state information-reference signal (CSI) corresponding to the transmission slot at a future time point, relative to reception times of the reference signals.

18. The user equipment of claim 17, wherein the channel estimation model comprises a machine learning model trained based on the reference signals comprising CSI-RSs.

19. The user equipment of claim 17, wherein the channel estimation model is configured to:
perform a first filtering operation to generate a first filtering value by applying a first weight vector to a first CSI-RS, and a second filtering operation to generate a second filtering value by applying a second weight vector to a second CSI-RS received after the first CSI-RS, from among the CSI-RSs;
perform an addition operation to generate a summed value by adding up the first filtering value to the second filtering value; and
generate the summed value as the predicted CSI, based on the second CSI-RS being a last received CSI-RS from among the CSI-RSs.

20. The user equipment of claim 19, wherein the processing circuitry comprises:
a filtering circuit configured to perform the first filtering operation and the second filtering operation;
an adder circuit configured to perform the addition operation; and
a prediction buffer configured to store the first filtering value, the second filtering value, and the summed value.
